(19) United States
(12) Patent Application Publication
(10) Pub. No.: US 2009/0309682 A1
(43) Pub. Date: Dec. 17, 2009

(54) Eight-fold dipole magnet array for generating a uniform magnetic field

(75) Inventor: David B. Hall, La Crescenta, CA (US)

Correspondence Address: John H. Lynn;#517, 5319 University Drive, Irvine, CA, 92612, US

(73) Assignee: Northrop Grumman Guidance and Electronic Company, Inc.

(21) Appl. No.: 12/157,880

(22) Filed: Jun. 13, 2008

(51) Int. Cl. H01F 7/02

(52) U.S. Cl. 335/306

(57) ABSTRACT

An array of permanent magnets is arranged to produce a uniform magnetic field for an NMR gyroscope cell. A magnet support structure has a plurality of sockets formed therein such that the plurality of sockets are located at the vertices of a rectangular parallelepiped. A magnet is mounted in each of the sockets with each magnet having a selected field strength and poling orientation. The magnets preferably are of identical structure and field strength. The magnets are preferably located at the vertices on a first side of the array in pairs having polarities directed away from one another and located at the vertices on a second side of the array in pairs having polarities directed toward one another.

### BACKGROUND OF THE INVENTION

This invention relates generally to magnetic fields and particularly to magnetic fields for nuclear magnetic resonance (NMR) gyroscopes. Still more particularly this invention relates to apparatus and methods for producing a uniform magnetic field for application to an NMR gyroscope alkali-noble gas cell to provide maximal access of pump and detection light beams to the cell.

An NMR gyroscope alkali-noble gas cell requires a uniform magnetic field in the cell. The uniform magnetic field should be produced with a minimum amount of power. The prior art uses electromagnetic coils, which consume substantial amounts of electrical power.

### SUMMARY OF THE INVENTION

The present invention uses an array of permanent magnets to produce a uniform magnetic field in an NMR gyroscope cell. A method for forming a uniform magnetic field in an NMR cell placed at a selected location, comprising the steps of providing a magnet support structure; forming a plurality of sockets in the magnet support structure such that the plurality of sockets are located at the vertices of a rectangular parallelepiped; and forming a magnet array by mounting a magnet in each of the sockets with each magnet having a selected field strength and poling orientation.

The magnets preferably are of identical structure and field strength.

The method of the present invention preferably further comprises the steps of arranging the magnets located at the vertices on a first side of the array in pairs having polarities directed away from one another; and arranging the magnets located at the vertices on a second side of the array in pairs having polarities directed toward one another.

### BRIEF DESCRIPTION OF THE DRAWINGS

FIG. 1 is a perspective view showing an eight-fold dipole magnet array according to the present invention;

FIG. 2 is a perspective view showing a frame that may be used to hold the magnets of FIG. 1 in a specified array configuration;

FIG. 3 is a perspective view showing a first alternative structure for holding the magnets of FIG. 1 in the illustrated array;

FIG. 4 is a second alternative structure for holding the magnets of FIG. 1;

FIG. 5 graphically illustrates magnetic field intensities along x, y and z axes for the dipole magnet configuration of FIG. 1;

FIG. 6 illustrates an alternate configuration of an eight-fold dipole magnet configuration according to the present invention; and

FIG. 7 graphically illustrates magnetic field intensities along x, y and z-axes for the dipole magnet configuration of FIG. 6.

### DETAILED DESCRIPTION OF THE INVENTION

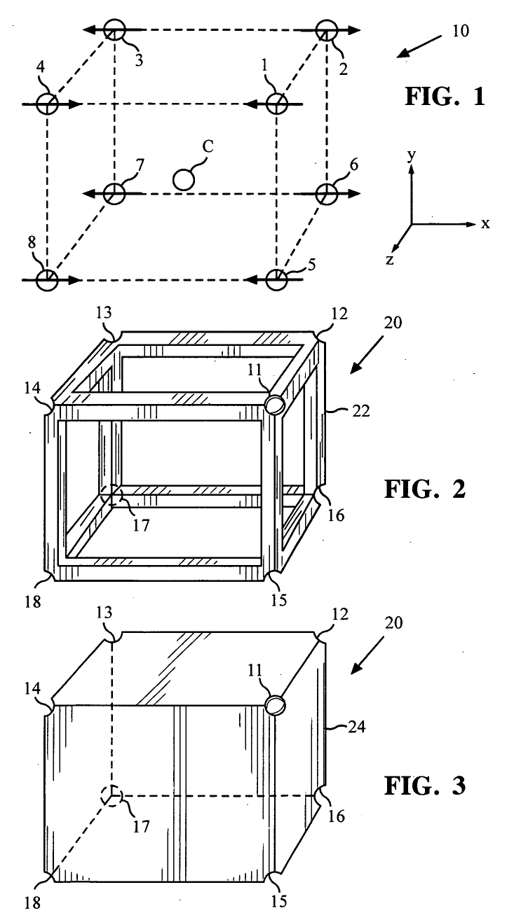

FIG. 1 illustrates an eight-fold dipole magnet array 10 according to the present invention. The magnet array 10 includes eight permanent magnets identified with reference numerals 1-8. The centers of the eight small spherical magnets 1-8 are located on corresponding corners of a rectangular volume that preferably extends 10 mm in the horizontal dimensions x and z and 5.744 mm in the vertical dimension y. The magnets 1-8 are uniformly poled along the ±x-axes. Table 1 provides a list of the magnet locations and the poling directions.

FIG. 2 shows a frame 20 that may be formed to include a plurality of sockets 11-18 arranged hold the magnets 1-8, respectively, of the array 10 in their respective positions shown in FIG. 1. The frame 20 of FIG. 2 has a plurality of frame members 22 arranged to enclose a volume that is in the form of a rectangular parallelepiped with the sockets 11-18 are located at its eight corners. The magnets 1-8 may be retained in the corresponding sockets 11-18 by an adhesive.

FIG. 3 shows an alternative way of providing the sockets 11-18. FIG. 3 shows the sockets 11-18 formed at the corners of a solid rectangular parallelepiped 24. A passage may be formed in the rectangular parallelepiped 24 by any convenient means such as boring so that an NMR cell (not shown) may be placed at its center to be subject to the desired magnetic field.

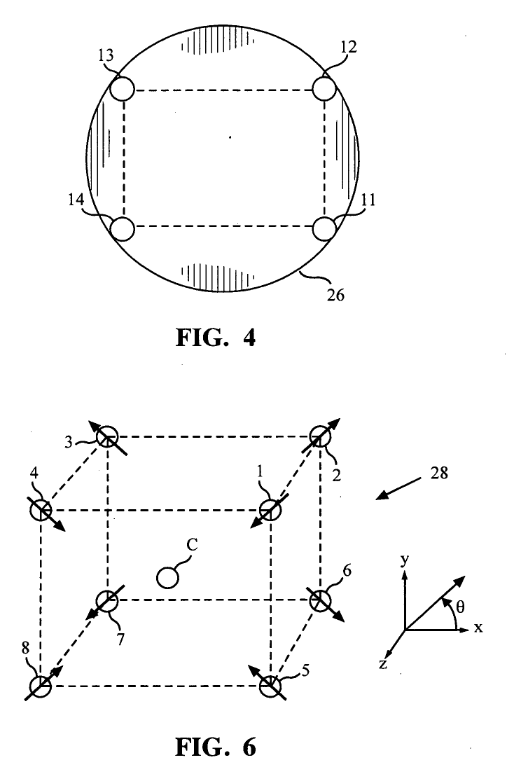

FIG. 4 shows a second alternative way of forming a support structure 26 for the magnets 1-8. FIG. 3 represents a top plan view of a cylinder having the sockets 11-14 formed at selected locations on the upper circular edge. The remaining sockets (not shown in FIG. 4) are formed in the bottom circular edge. Several additional ways of forming the support structure for the magnets are possible. The support structures presented herein are intended to be examples rather than a complete list.

An NMR cell (not shown) located in the center C of the rectangular array 10 exhibits a uniform magnetic field intensity along the z-axis and extremely small magnetic field intensities along the x and y axes. The magnitude of the magnetic field is a function of the pole strength of the individual magnets 1-8. For example, samarium cobalt spherical magnets having diameters of 0.47 mm and uniformly poled to a field strength of 10,000 Gauss produce a field of 1.0 Gauss in the center of the rectangular volume.

With no shielding, the exact solution for the magnetic field in the vicinity of a spherical uniformly poled permanent magnet is the same as that for the far field of a magnetic dipole. The magnetic field as a function of position may be expressed as:

$$B ( r ) = \frac{[ 3 n ( n \cdot m ) - m ]}{{\vert r \vert}^{3}} , \qquad ( 1 )$$

where B is the magnetic field; n is a unit vector pointing from the magnet center to the observer's location; m is the magnetic moment of the magnet; and r is the vector distance from the magnet center to the observer's location.

In terms of the pole strength B₀, the magnetic moment is:

$$m = \frac{{a}^{3} {B}_{o}}{3} , \qquad ( 2 )$$

where a is the radius of the sphere. At the point on the sphere where n and m are aligned, the magnetic field is also aligned to the magnetic moment m and has a field strength of ⅔ B₀.

TABLE 1
MAGNET LOCATIONS AND POLING DIRECTIONS RELATIVE
TO CENTER OF MAGNET ARRAY

| Magnet # | x (mm) | y (mm) | z (mm) | Poling Direction |
|---|---|---|---|---|
| 1 | +5 | +2.872 | +5 | −x |
| 2 | +5 | +2.872 | −5 | +x |
| 3 | −5 | +2.872 | −5 | −x |
| 4 | −5 | +2.872 | +5 | +x |
| 5 | +5 | −2.872 | +5 | −x |
| 6 | +5 | −2.872 | −5 | +x |
| 7 | −5 | −2.872 | −5 | −x |
| 8 | −5 | −2.872 | +5 | +x |

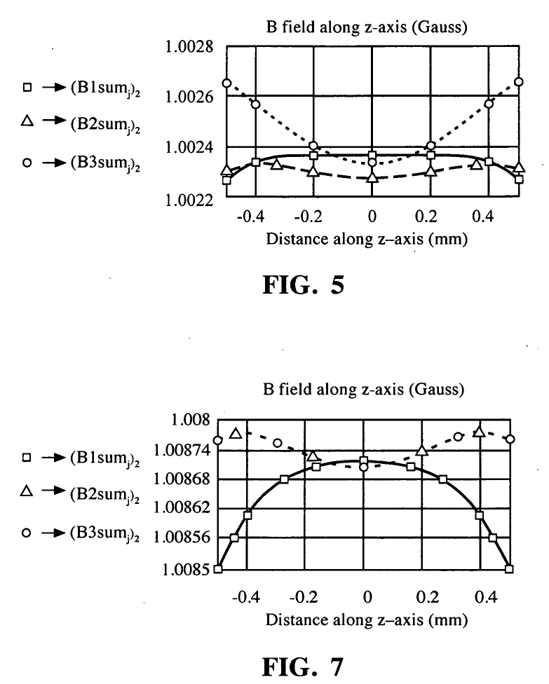

The solution to the magnetic field produced by the eight magnets 1-8 shown in FIG. 1 is the eight-fold superposition of Eq. (1) for a single magnet. A plot is shown in FIG. 5 to characterize the magnetic fields along the x, y, and z-axes in the central region C of the rectangular volume shown in FIG. 1. The spherical magnets 1-8 are preferably 0.47 mm in diameter and poled to a field strength of 10,000 gauss.

The plot shows three curves representing fields along the z axis from −0.5 mm to +0.5 mm from the center C. The solid curve indicted by squares is the field along the z-axis with x and y equal to zero. The dotted curve indicated by circles is the field at x=0.4 mm and y=0 whereas the black dashed curve indicated by triangles is the field at x=0 and y=0.4 mm. For an NMR cell with interior dimensions of 1.0 mm on a side, the solid line curve indicted by squares represents the field centered within the cell cross-section whereas the other two curves represent the field at a distance of 0.1 mm from the cell wall.

Table 2 is a summary of the magnetic field data for the array 10. The baseline is B_{z}=1.0 gauss, Bₓ=0, and B_{y}=0. Field variations are given in terms of parts per million (ppm) for the peak-to-peak range of all three curves on each plot referenced to one gauss.

TABLE 2
PEAK-TO-PEAK MAGNETIC FIELD VARIATIONS IN PPM

| Errors in poling strength, | | | |
|---|---|---|---|
| poling angle or location | | | |
| of one magnet | B_{z} (ppm) | Bₓ (ppm) | B_{y} (ppm) |
| No errors | 400 | 200 | 0 |
| 1.0% error in poling strength | 500 | 350 | 300 |
| 0.01 radian poling angle along y-axis | 600 | 500 | 100 |
| 0.01 radian poling angle along z-axis | 700 | 500 | 250 |
| 0.05 mm location error along x-axis | 1100 | 450 | 600 |
| 0.05 mm location error along y-axis | 1150 | 800 | 50 |
| 0.05 mm location error along z-axis | 1000 | 900 | 800 |

Table 2 shows that the magnetic field uniformity within the NMR cell located at the center C of the array 10 is of the order of several hundred ppm for no errors in magnet poling strength, magnet poling angle, or magnet location. Sizeable errors in these parameters introduce additional errors of several hundred ppm. This demonstrates the absence of excessive sensitivity of magnetic field variation to magnet poling and location errors.

Another eight-fold dipole magnet array 28 that produces a uniform magnetic field is shown in FIG. 6. Table 3 gives a list of the magnet locations and the poling directions in the xy plane. A pole strength of 10,000 Gauss requires a magnet diameter of 0.45 mm for a 1.0 Gauss filed in the center of the rectangular volume.

TABLE 3
MAGNET LOCATIONS AND POLING DIRECTIONS

| Magnet # | x (mm) | y (mm) | z (mm) | Poling angle in xy plane |
|---|---|---|---|---|
| 1 | +4.09 | +4.09 | +5 | −135° |
| 2 | +4.09 | +4.09 | −5 | +45° |
| 3 | −4.09 | +4.09 | −5 | +135° |
| 4 | −4.09 | +4.09 | +5 | −45° |
| 5 | +4.09 | −4.09 | +5 | +135° |
| 6 | +4.09 | −4.09 | −5 | −45° |
| 7 | −4.09 | −4.09 | −5 | −135° |
| 8 | −4.09 | −4.09 | +5 | +45° |

As was done before for the magnet array 10 of FIG. 1, magnetic fields along x, y, and z are plotted from −0.5 mm to +0.5 mm along z. FIG. 7 show the fields with no errors in magnet poling strength, poling direction, and magnet location. Additional data is presented in Table 4 for seven magnets all equal in poling strength and with no errors in poling angle and magnet location. The eighth magnet has errors introduced in poling strength, poling angle, or location to determine the influence of these errors on magnetic field uniformity within the NMR cell located in the central region of the magnet array 20.

The sensitivity data is summarized in Table 4 for the array 20 in the same fashion as Table 2 for the first array 10.

TABLE 4
PEAK-TO-PEAK MAGNETIC FIELD VARIATIONS IN PPM

| Errors in poling strength, | | | |
|---|---|---|---|
| poling angle or location | | | |
| of one magnet | B_{z} (ppm) | Bₓ (ppm) | B_{y} (ppm) |
| No errors | 300 | 200 | 0 |
| 1.0% error in poling strength | 650 | 450 | 350 |
| 0.01 radian poling angle along y-axis | 350 | 350 | 150 |
| 0.01 radian poling angle along z-axis | 450 | 400 | 350 |
| 0.05 mm location error along x-axis | 1050 | 400 | 600 |
| 0.05 mm location error along y-axis | 1050 | 600 | 50 |
| 0.05 mm location error along z-axis | 250 | 700 | 500 |

The results from Table 4 for the alternate magnet array 28 are similar to the results from Table 2 for the first magnet array 10.

Referring to FIG. 6, an NMR cell in the middle of the rectangular volume is easily visualized as being another rectangular volume oriented along the x, y, and z axes. The cell can also be rotated 45° about the z-axis for another orientation with maximum symmetry.

The analysis presented so far is exact with spherical, uniformly poled magnets with no shielding. In the far field limit for dipole magnets, Eq. (1) yields a solution that is independent of magnet shape. The two configurations presented here used magnets with a diameter of roughly ten percent of the distance from the magnet to the central field region. In this case, the magnet shape need not be spherical. Other shapes that would work include cubes poled along an edge or right circular cylinders poled along the cylinder axis.

The addition of a shield around the magnet assembly is necessary to eliminate stray magnetic fields. The relative locations of the magnets will change as the shield is introduced in order to keep a uniform field component B_{z} at the center. With appropriate symmetry considerations for the shield, the rectangular solid volume with the magnets on the corners will be maintained with changes in its relative dimensions.

This type of reasoning is analogous to solenoid coil design with a secondary coil for maintaining a uniform field. The addition of a cylindrical shield necessitates a change in the length of the secondary coil relative to the length of the primary coil in order to maintain a very uniform field within the central region.

Auxiliary wire coils carrying extremely small currents can be placed in the vicinity of the magnet assembly to fine tune the central magnetic field for greater uniformity. Coils along three orthogonal axes can be used to fine tune the x, y, and z fields.

The magnets are all the same and can be mass produced and uniformly poled at the same time. The placement of the magnets on an assembly harness with some adjustment features is a way to minimize variations in the central magnetic field. Cherry-picking of magnets is another way to improve field uniformity. Once the magnets have been made, they can be checked for diameter and poling strength before installation into an assembly harness.

What is claimed is:

1. A method for forming a uniform magnetic field in an NMR cell placed at a selected location, comprising the steps of:
providing a magnet support structure;
forming a plurality of sockets in the magnet support structure such that the plurality of sockets are located at the vertices of a rectangular parallelepiped; and
forming a magnet array by mounting a magnet in each of the sockets with each magnet having a selected field strength and poling orientation.

2. The method of claim 1 wherein magnets of identical structure and field strength are mounted in the sockets.

3. The method of claim 2, further comprising the steps of:
arranging the magnets located at the vertices on a first side of the array in pairs having polarities directed away from one another; and
arranging the magnets located at the vertices on a second side of the array in pairs having polarities directed toward one another.

4. Apparatus for forming a uniform magnetic field in an NMR cell placed at a selected location, comprising:
a magnet support structure having a plurality of sockets formed therein with the plurality of sockets being located at the vertices of a rectangular parallelepiped; and
a magnet array comprising a magnet mounted in each of the sockets with each magnet having a selected field strength and poling orientation.

5. The apparatus of claim 4 wherein magnets have identical structure and field strength.

6. The method of claim 5 wherein the magnets located at the vertices on a first side of the array are arranged in pairs having polarities directed away from one another and the magnets located at the vertices on a second side of the array are arranged in pairs having polarities directed toward one another.
